(19) United States
(12) Patent Application Publication
(10) Pub. No.: US 2013/0050674 A1
(43) Pub. Date: Feb. 28, 2013

(54) LITHOGRAPHIC APPARATUS, SUBSTRATE TABLE AND DEVICE MANUFACTURING METHOD

(71) Applicants: Vitaliy Prosyentsov, Deurne (NL); Johannes Maria Van Benten, Eindhoven (NL)

(72) Inventors: Vitaliy Prosyentsov, Deurne (NL); Johannes Maria Van Benten, Eindhoven (NL)

(73) Assignee: ASML Netherlands B.V., Veldhoven (NL)

(21) Appl. No.: 13/315,912

(22) Filed: Dec. 9, 2011

Related U.S. Application Data
(60) Provisional application No. 61/526,943, filed on Aug. 24, 2011.

(51) Int. Cl. G03B 27/58

(52) U.S. Cl. 355/72; 355/77

(57) ABSTRACT

A substrate table with a sensor that includes a block of material provided with a layer of material opaque to radiation. The layer of material has at least one window configured to allow the transmission of the radiation. The sensor includes a wavelength conversion material located at the window, and a waveguide positioned to receive radiation emitted by the wavelength conversion material. The waveguide is embedded in the block of material and configured to guide radiation emitted by the wavelength conversion material through the block of material and towards a detector.

### CROSS-REFERENCE TO RELATED APPLICATIONS

This application claims the benefit of priority from U.S. Provisional Patent Application No. 61/526,943, filed Aug. 24, 2011, the entire content of which is incorporated herein by reference.

### FIELD

The present invention relates to a lithographic apparatus, a substrate table, and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

$$CD = {k}_{1} * \frac{λ}{NA} \qquad ( 1 )$$

where λ is the wavelength of the radiation used, NA is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA or by decreasing the value of k₁.

In order to shorten the exposure wavelength and, thus, reduce the minimum printable size, it has been proposed to use an extreme ultraviolet (EUV) radiation source. EUV radiation is electromagnetic radiation having a wavelength within the range of 5-20 nm, for example within the range of 13-14 nm, or example within the range of 5-10 nm such as 6.7 nm or 6.8 nm. Possible sources include, for example, laser-produced plasma sources, discharge plasma sources, or sources based on synchrotron radiation provided by an electron storage ring.

EUV radiation may be produced using a plasma. A radiation system for producing EUV radiation may include a laser for exciting a fuel to provide the plasma, and a source collector module for containing the plasma. The plasma may be created, for example, by directing a laser beam at a fuel, such as particles of a suitable material (e.g. tin), or a stream of a suitable gas or vapor, such as Xe gas or Li vapor. The resulting plasma emits output radiation, e.g., EUV radiation, which is collected using a radiation collector. The radiation collector may be a mirrored normal incidence radiation collector, which receives the radiation and focuses the radiation into a beam. The source collector module may include an enclosing structure or chamber arranged to provide a vacuum environment to support the plasma. Such a radiation system is typically termed a laser produced plasma (LPP) source.

It is desirable to ensure that a pattern projected onto a substrate is aligned with patterns already located on the substrate. This may be done by using an alignment apparatus to align the mask with a substrate table which holds the substrate, thereby allowing alignment of the mask relative to the substrate to be determined. In order to align the mask with the substrate table, the substrate table may be provided with a sensor.

Typically the sensors used to align the mask with the substrate table detect the EUV radiation and measure the light intensity by a diffraction grating in various positions to create an intensity distribution in space. The diffraction grating consists of a number of openings (windows). Below these openings a photo detector may be positioned to detect the light transmitted through some or all the openings (complete grating).

The alignment sensor plate may need to be moved because the resolution of the aerial image sampling scheme of the sensor grating is limited by the size of the grating (which size should be kept as small as possible for an optimal use of space on the photo mask). Moreover, currently available photo detectors are rather large, thereby preventing the use of multiple detectors for a plurality of gratings close to each other. In order to measure light intensity precisely, the sensor grating should be moved in space and it should be controlled with high precision. The sensor movement needs time, elaborate control systems, machine resources and stability over the period of movement.

In addition, electrical signals from photo detectors are typically weak and can easily pick-up electromagnetic noise. Therefore, electrical signal lines between photodiodes and pre-amplifiers are desirably kept short and the preamplifiers are typically placed close to the photo detectors. The pre-amplifiers generate heat that may contribute to the deformation of the alignment sensor grating, which may ultimately leading to errors in the calculation of the aligned position. Moreover, the photo detectors and electronics form bulky structures (which also prevent miniaturisation and use of multiple detectors) and require special alignment inside the sensor.

It is desirable to provide a lithographic apparatus with a substrate table having a sensor that solves one or more of the above mentioned potential disadvantages.

### SUMMARY

According to an aspect of the invention, there is provided substrate table with a sensor, the sensor comprising a block of material provided with a layer of material opaque to radiation, the layer of material having at least one window configured to allow the transmission of the radiation, the sensor further comprising a wavelength conversion material located at the window, and a waveguide positioned to receive radiation emitted by the wavelength conversion material, the waveguide being embedded in the block of material and configured to guide radiation emitted by the wavelength conversion material through the block of material and towards a detector.

The block of material may be a semiconductor chip or a dielectric block.

The waveguide may have a height and/or width of less than 30 microns.

The detector may be provided in the substrate table.

The detector may be provided in the semiconductor chip, or be provided next to the semiconductor chip.

The detector may be one of a plurality of detectors.

The window may be one of a plurality of windows.

A set of windows may extend in a first direction, and at least some of the windows may have different positions in a second direction, the second direction being transverse (i.e. perpendicular) to the first direction.

At least some of the windows may be provided at different heights.

Each window may be provided with a separate piece of wavelength conversion material.

The waveguide may be one of a plurality of waveguides.

Each window may be associated with a different waveguide.

At least some of the waveguides may extend to different depths within the semiconductor chip.

At least some of the waveguides may be spaced laterally apart from each other.

A dopant configured to amplify the radiation emitted by the wavelength conversion material may be provided in the waveguide, and an optical pump may be arranged to directly pump radiation into the waveguide, the pump radiation having a wavelength configured to excite the dopant.

The wavelength conversion material may be configured to emit radiation having a wavelength in the wavelength range 500-2000 nm when EUV radiation is incident upon the wavelength conversion material.

The layer of opaque material may be opaque to EUV radiation. The layer of opaque material may be opaque to radiation in the wavelength range 500-2000 nm.

According to an aspect of the invention, there is provided a lithographic apparatus comprising an illumination system configured to condition a radiation beam, a support constructed to support a patterning device, the patterning device being capable of imparting the radiation beam with a pattern in its cross-section to form a patterned radiation beam, a substrate table according to any preceding aspect of the invention, the substrate table being constructed to hold a substrate, and a projection system configured to project the patterned radiation beam onto a target portion of the substrate.

According to an aspect of the invention, there is provided a device manufacturing method comprising using the lithographic apparatus of embodiments of the invention to manufacture devices, wherein the method includes using the sensor to measure an optical property of an EUV radiation beam, and using the sensor to measure alignment of the substrate table and a mask.

According to an aspect of the invention, there is provided a lithographic apparatus comprising an illumination system configured to condition a radiation beam, a support constructed to support a patterning device, the patterning device being capable of imparting the radiation beam with a pattern in its cross-section to form a patterned radiation beam, a substrate table with a sensor, the sensor comprising a block of material provided with a layer of material opaque to radiation, the layer of material having at least one window configured to allow the transmission of the radiation, a wavelength conversion material located at the window, and a waveguide positioned to receive radiation emitted by the wavelength conversion material, the waveguide being embedded in the block of material and being configured to guide radiation emitted by the wavelength conversion material through the block of material and towards a detector, the substrate table being constructed to hold a substrate, and a projection system configured to project the patterned radiation beam onto a target portion of the substrate.

According to an aspect of the invention, there is provided a device manufacturing method comprising using a lithographic apparatus comprising an illumination system configured to condition a radiation beam; a support constructed to support a patterning device, the patterning device being capable of imparting the radiation beam with a pattern in its cross-section to form a patterned radiation beam; a substrate table with a sensor, the sensor comprising a block of material provided with a layer of material opaque to radiation, the layer of material having at least one window configured to allow the transmission of the radiation, a wavelength conversion material located at the window, and a waveguide positioned to receive radiation emitted by the wavelength conversion material, the waveguide being embedded in the block of material and being configured to guide radiation emitted by the wavelength conversion material through the block of material and towards a detector, the substrate table being constructed to hold a substrate; and a projection system configured to project the patterned radiation beam onto a target portion of the substrate, using the sensor to measure an optical property of an EUV radiation beam, and using the sensor to measure alignment of the substrate table and the patterning device.

According to an aspect of the invention, there is provided a device manufacturing method comprising patterning an EUV beam of radiation with a pattering device, projecting a patterned beam of radiation onto a substrate supported by a substrate table with a projection system, measuring an optical property of the EUV radiation beam with a sensor in the substrate table, the sensor comprising a block of material provided with a layer of material opaque to radiation, the layer of material having at least one window configured to allow the transmission of the radiation, a wavelength conversion material located at the window, and a waveguide positioned to receive radiation emitted by the wavelength conversion material, the waveguide being embedded in the block of material and being configured to guide radiation emitted by the wavelength conversion material through the block of material and towards a detector, and measuring alignment of the substrate table and the patterning device with the sensor.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 is a more detailed view of the apparatus of FIG. 1;

FIG. 3 is a schematic view of the substrate table and a sensor of the lithographic apparatus according to an embodiment of the invention;

FIG. 4 is a schematic view of the sensor of FIG. 3;

FIG. 5 is a schematic view of an embodiment of the sensor;

FIG. 6 is a schematic view of part of the sensor according to an embodiment of the invention; and

FIG. 7 is a schematic view of part of the sensor according to an embodiment of the invention.

### DETAILED DESCRIPTION

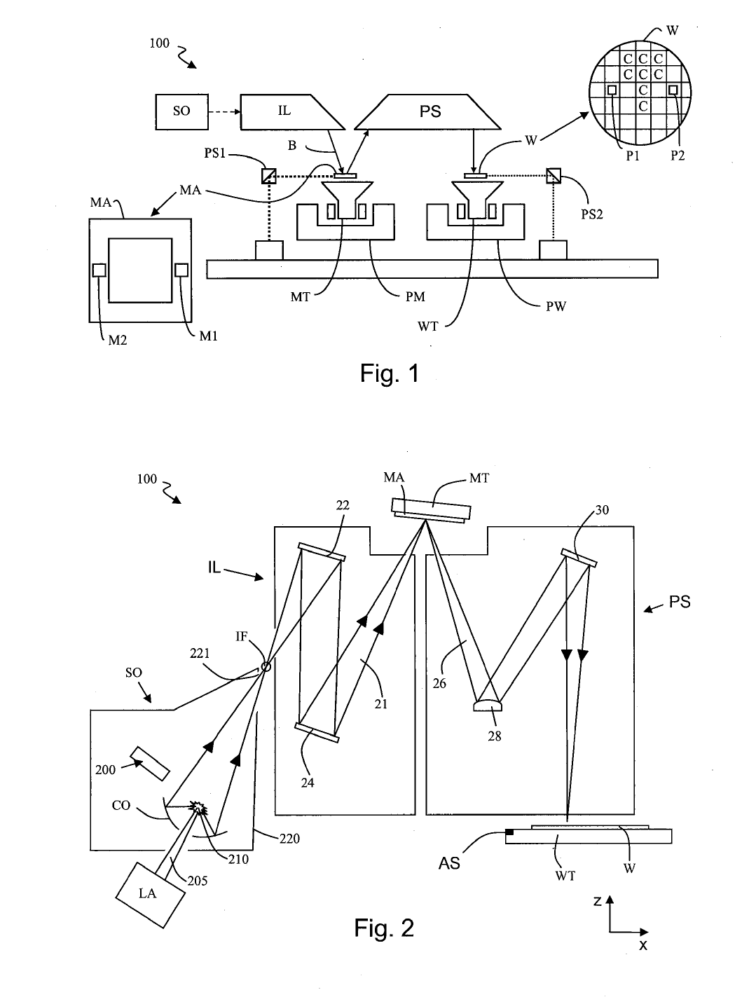

FIG. 1 schematically depicts a lithographic apparatus 100 including a source collector module SO according to one embodiment of the invention. The apparatus comprises: an illumination system (illuminator) IL configured to condition a radiation beam B (e.g. EUV radiation); a support structure (e.g. a mask table) MT constructed to support a patterning device (e.g. a mask or a reticle) MA and connected to a first positioner PM configured to accurately position the patterning device; a substrate table (e.g. a wafer table) WT constructed to hold a substrate (e.g. a resist-coated wafer) W and connected to a second positioner PW configured to accurately position the substrate; and a projection system (e.g. a reflective projection system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam that is reflected by the mirror matrix.

The projection system, like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since other gases may absorb too much radiation. A vacuum environment may therefore be provided to the whole beam path with the aid of a vacuum wall and vacuum pumps.

As here depicted, the apparatus is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultra violet (EUV) radiation beam from the source collector module SO. Methods to produce EUV light include, but are not necessarily limited to, converting a material into a plasma state that has at least one element, e.g., xenon, lithium or tin, with one or more emission lines in the EUV range. In one such method, often termed laser produced plasma (“LPP”) the required plasma can be produced by irradiating a fuel, such as a droplet, stream or cluster of material having the required line-emitting element, with a laser beam. The source collector module SO may be part of an EUV radiation system including a laser, not shown in FIG. 1, for providing the laser beam exciting the fuel. The resulting plasma emits output radiation, e.g. EUV radiation, which is collected using a radiation collector, disposed in the source collector module. The laser and the source collector module may be separate entities, for example when a CO₂ laser is used to provide the laser beam for fuel excitation.

In such cases, the laser is not considered to form part of the lithographic apparatus and the radiation beam is passed from the laser to the source collector module with the aid of a beam delivery system comprising, for example, suitable directing mirrors and/or a beam expander. In other cases, the source may be an integral part of the source collector module, for example when the source is a discharge produced plasma EUV generator, often termed as a DPP source.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as facetted field and pupil mirror devices. The illuminator may be used to condition the radiation beam, to have a desired uniformity and intensity distribution in its cross-section.

The radiation beam B is incident on the patterning device (e.g. mask) MA, which is held on the support structure (e.g. mask table) MT, and is patterned by the patterning device. After being reflected from the patterning device (e.g. mask) MA, the radiation beam B passes through the projection system PS, which focuses the beam onto a target portion C of the substrate W. With the aid of the second positioner PW and position sensor PS2 (e.g. an interferometric device, linear encoder or capacitive sensor), the substrate table WT can be moved accurately, e.g. so as to position different target portions C in the path of the radiation beam B. Similarly, the first positioner PM and another position sensor PS1 can be used to accurately position the patterning device (e.g. mask) MA with respect to the path of the radiation beam B. Patterning device (e.g. mask) MA and substrate W may be aligned using mask alignment marks M1, M2 and substrate alignment marks P1, P2.

The depicted apparatus could be used in at least one of the following modes:

1. In step mode, the support structure (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.
2. In scan mode, the support structure (e.g. mask table) MT and the substrate table WT are scanned synchronously while a pattern imparted to the radiation beam is projected onto a target portion C (i.e. a single dynamic exposure). The velocity and direction of the substrate table WT relative to the support structure (e.g. mask table) MT may be determined by the (de-) magnification and image reversal characteristics of the projection system PS.
3. In another mode, the support structure (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2 shows the apparatus 100 in more detail, including the source collector module SO, the illumination system IL, and the projection system PS. The source collector module SO is constructed and arranged such that a vacuum environment can be maintained in an enclosing structure 220 of the source collector module SO. In an embodiment, an EUV emitting plasma 210 may be produced by irradiating a fuel, such as a droplet, stream or cluster of material having the required line-emitting element provided by a fuel source 200, with a laser beam 205 emitted from a light source LA, such as a laser. In an embodiment, an EUV radiation emitting plasma 210 may be formed by a discharge produced plasma source. EUV radiation may be produced by a gas or vapor, for example Xe gas, Li vapor or Sn vapor in which the very hot plasma 210 is created to emit radiation in the EUV range of the electromagnetic spectrum. The very hot plasma 210 is created by, for example, an electrical discharge causing an at least partially ionized plasma. Partial pressures of, for example, 10 Pa of Xe, Li, Sn vapor or any other suitable gas or vapor may be required for efficient generation of the radiation. In an embodiment, a plasma of excited tin (Sn) is provided to produce EUV radiation.

The source collector module SO may include a radiation collector CO, which may be a so called normal incidence radiation collector. Radiation that is reflected by the radiation collector CO is focused in a virtual source point IF. The virtual source point IF is commonly referred to as the intermediate focus, and the source collector module is arranged such that the intermediate focus IF is located at or near an opening 221 in the enclosing structure 220. The virtual source point IF is an image of the radiation emitting plasma 210.

Subsequently the radiation traverses the illumination system IL, which may include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the substrate table WT.

More elements than shown may generally be present in illumination optics unit IL and projection system PS. A grating spectral filter may optionally be present, depending upon the type of lithographic apparatus. Further, there may be more mirrors present than those shown in the Figures, for example there may be 1-6 additional reflective elements present in the projection system PS than shown in FIG. 2.

The substrate table WT is provided with an alignment sensor AS according to an embodiment of the invention.

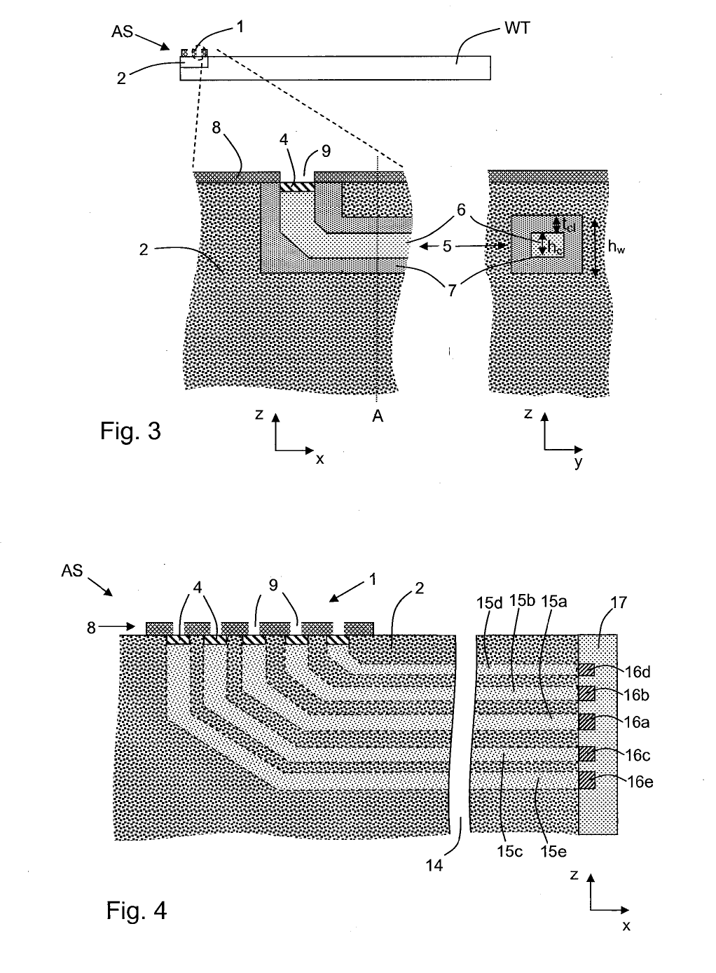

FIG. 3 schematically shows a substrate table WT that corresponds with the substrate table shown in FIGS. 1 and 2. An alignment sensor AS is provided in the substrate table WT. The alignment sensor AS includes a grating 1, which is represented schematically by a series of lines. Although only three lines are shown in FIG. 3, the grating 1 may comprise any suitable number of lines. The grating 1 may for instance be a diffraction grating used for alignment (i.e. an alignment grating). The alignment sensor AS is formed in a block of material, which in this embodiment is a semiconductor chip 2 (e.g. formed from silicon or some other suitable semiconductor). Part of the semiconductor chip 2 is shown in an enlarged view beneath the substrate table WT in FIG. 3.

As may be seen from the enlarged view, the alignment sensor AS comprises a wavelength conversion material 4 and a waveguide 5. The waveguide is embedded in the semiconductor chip 2 and is configured to receive and guide radiation emitted by the wavelength conversion material 4. The waveguide 5 comprises a core 6 and cladding 7, the cladding surrounding the core. The core 6 has a higher refractive index from the cladding 7. This difference in refractive index is sufficiently large that radiation emitted by the wavelength conversion material 4 is substantially confined by the waveguide, so that the radiation is guided along the waveguide 5. The wavelength conversion material may for example be a material that emits infrared or visible radiation when EUV radiation is incident upon it. The wavelength conversion material may for example emit radiation in the range 500-2000 nm.

Part of the alignment grating 1 is shown in the enlarged view. The alignment grating comprises a layer of material 8 that is opaque to EUV radiation, the layer of material being provided with a window 9. The opaque material 8 may for example be aluminium, or may be any other suitable material. The opaque material 8 blocks EUV radiation, whereas EUV radiation may pass through the window 9. The opaque material 8 and the window 9 thus form part of the alignment grating.

FIG. 3 also schematically shows the semiconductor chip 2 in cross-section along line A. As may be seen, the waveguide 5 has a rectangular cross-section (although it may have any other suitable cross-sectional shape). The height h_{c} of the core 6 (and the width) may be of the order of the wavelength of radiation that is emitted by the wavelength conversion material 4, or may be greater than this. In this context the wavelength of the radiation is the wavelength of the radiation when it is in the core 6, which will be significantly shorter than the wavelength of the radiation in air. The thickness (and the width) of the core 6 may be less than the wavelength of radiation that is emitted by the conversion material. However, if it is significantly less, then this may give rise to substantial losses of radiation as the radiation travels along the waveguide. In general, the smaller the core 6, the more radiation will be lost from the waveguide as the radiation propagates, particularly at corners or curves of the waveguide. The smaller the core 6, the less radiation is inside the core and more radiation is outside the core. The radiation that is outside the core 6 will be inside the cladding 7. However, if the cladding is not sufficiently thick, then radiation will leak from the cladding into the semiconductor chip 2, thereby reducing the amount of radiation that is available for detection by a detector. Conversely, if the core is bigger, then more radiation will be retained in the core, and more radiation will be available for detection by the detector. In addition, a bigger core may collect more radiation from the wavelength conversion material 4.

The thickness t_{cl} of the cladding 7 may be of the order of the wavelength of radiation that is emitted by the wavelength conversion material 4, or may be greater than this. In this context, the wavelength of the radiation is the wavelength of the radiation when it is in the cladding 7, which will be significantly shorter than the wavelength of the radiation in air. Although the cladding 7 may have a thickness that corresponds with the wavelength of radiation that is emitted by the wavelength conversion material 4, the cladding may be thicker than this. Providing thicker cladding may reduce the amount of radiation that is lost when the radiation travels along the waveguide 6, since less radiation will leak from the cladding into the semiconductor chip 2.

The height h_{w} of the waveguide 5 may be three or more times the wavelength of the radiation that is emitted by the wavelength conversion material 4. The width of the waveguide 5 may similarly be three or more times the wavelength of the radiation that is emitted by the wavelength conversion material 4.

The wavelength conversion material 4 may, for example, emit infrared or visible radiation. The height of the core may therefore, for example, be less than 10 microns, less than 5 microns, less than 2 microns, or less than 1 micron. The width of the core may, for example, be less than 10 microns, less than 5 microns, less than 2 microns, or less than 1 micron. The thickness of the cladding may, for example, be less than 10 microns, less than 5 microns, less than 2 microns, or less than 1 micron. The height and/or width of the waveguide may thus be less than 30 microns, less than 15 microns, less than 6 microns, or less than 3 microns.

The opaque material 8 may, for example, be Al, Cu, TiN, or any other suitable material (e.g. metal). The opaque material may, for example, be provided as a layer that is around 100 nm thick, or as a layer with some other suitable thickness.

The waveguide core 6 may be formed from Si, SiO₂, SiC, Si₃N₄, InGaAsP, or any other suitable material (e.g. any suitable semiconductor such as semiconductor formed from III-V group and/or II-VI group elements and/or group IV elements). The waveguide cladding 7 may be formed from SiO₂, Si₃N₄, SiC, InGaAsP or any other suitable material (e.g. any suitable semiconductor such as semiconductor formed from III-V group and/or II-VI group elements, and/or group IV elements). The waveguide cladding 7 may consist of the same material as the semiconductor chip 2. Where InGaAsP is used, this may be provided in an InP block or a GaAs block (e.g. the semiconductor chip 2 may be formed from InP or GaAs). Where Si, SiC or Si₃N₄ is used, this may be provided in a Si or SiO₂ block (e.g. the semiconductor chip 2 may be formed from Si). Alternatively, the semiconductor chip may be formed from CdTe. The semiconductor chip 2 may be formed from any suitable semiconductor material (e.g. semiconductor formed from III-V group and/or II-VI group elements, or from group IV elements such as Ge). The semiconductor material used to form the semiconductor chip 2 may have a lattice that is matched to the lattice of materials used to form the cladding 7 and core 6. The semiconductor material used to form the semiconductor chip 2 may have a lattice with dimensions that are sufficiently close to the lattice dimensions of the cladding 7 and core 6 that stresses arising at material interfaces do not cause the waveguide 5 to be formed incorrectly.

Where InGaAsP is used, its optical properties (including refractive index) and mechanical properties may be tuned by changing the relative concentrations of the constituent materials. For In(x)Ga(1-x)As(y)P(1-y) the values of x and y may be varied between 0 and 1 to change the relative concentrations and tune the optical and mechanical properties. Similarly, optical properties of other materials may be tuned by changing the relative concentrations of constituent materials.

As mentioned above, the refractive index n_{c} of the core 6 is greater than the refractive index n_{cl} of the cladding 7, i.e. n_{c}>n_{cl}.

The wavelength of radiation generated by the wavelength conversion material 4 may be taken into account when choosing which material to use to form the waveguide core 6 and cladding 7 (e.g. materials that are substantially transmissive at that wavelength may be chosen).

The wavelength conversion material 4 may, for example, be a scintillation material such as YAG:Ce, or any other suitable scintillation material. The scintillation material may for example be P43. P43 is a phosphorus formed by using Td to activate a Gd₂O₂S host material.

The wavelength conversion material 4 may be a semiconductor. EUV radiation photons have an energy of around 90 eV, and thus provide enough energy to excite electrons in a semiconductor material. If the semiconductor material has a direct bandgap, then photons will be emitted when these electrons relax to the ground state. Suitable direct bandgap semiconductors are semiconductors from the III-V group and the II-VI group. It may be desirable that the wavelength conversion material emits radiation having a wavelength in the range 500-2000 nm, since relatively low loss waveguides may be constructed to guide radiation in this wavelength range. This wavelength range corresponds with a photon energy in the range 0.6-2.4 eV. A semiconductor material that has a bandgap that falls within this range may be used as the wavelength conversion material. Semiconductor materials that have bandgaps in this range include GaAs (bandgap around 1.4 eV), AlGaAs (bandgap around 1.42-2.16 eV), InGaAs (bandgap around 0.36-1.43 eV), and InGaAsP (bandgap around 0.9-1.3 eV). Other semiconductor materials may be used. Properties of the wavelength conversion material 4 may be tuned by changing the relative concentrations of constituent materials.

Fabrication of the semiconductor chip 2, including the waveguide 5, may be via conventional lithographic techniques or other techniques known in the art. Patterns may be exposed onto resist, processed and etched, in order to form the waveguides and the alignment grating, and may be used to form the wavelength conversion material. The lithographic techniques may, for example, use Si and materials that may be grown on Si. However, the lattice dimensions of materials such as GaAs and AlGaAs are different from Si, and it may therefore not be possible to grow these materials onto Si (or related materials). Therefore, the wavelength conversion material 4 may be provided by gluing the material onto the semiconductor chip 2 rather than growing it. For example, once the waveguide 5 has been formed, the wavelength conversion material 4 (e.g. InGaAs or AlGaAs) may be glued onto the top of the waveguide, the wavelength conversion material being provided as a layer that extends across the semiconductor chip (and potentially across a plurality of semiconductor chips). In an alternative method, the wavelength conversion material may be bonded to the semiconductor chip 2 using Van der Waals bonding. It is also possible to glue or bond semiconductors from the III-V group on Si chips or wafers. Following gluing or bonding of the wavelength conversion material 4 onto the waveguide, lithographic patterning and etching may be used to remove unwanted wavelength conversion material, such that the wavelength conversion material remains only in a desired location or locations (e.g. as shown in FIG. 3). Additional semiconductor chip material and cladding material may then be provided on the semiconductor chip using conventional lithographic techniques. Following this, the alignment grating 1 may be formed using conventional lithographic techniques.

The semiconductor chip 2 may be one of a plurality of semiconductor chips that are all formed together on a semiconductor wafer (also referred to as a substrate).

The cladding 7 may be formed from a single material or may be formed from a combination of materials. Different materials may be used to form the cladding 7 on different sides of the core 6. For example, the materials used to form the cladding 7 above the core 6 may be different from the materials used to form the cladding beneath the core and/or may be different from the materials used to form the cladding on the left and/or right sides of the core.

The core 6 may be formed from different materials. For example, alternating layers of semiconductor may be used to form the core 6. In an embodiment, alternating layers of InGaAsP and InP may be used to form the core 6. This may be done to provide the core 6 with a desired refractive index.

FIG. 3 shows only one window 9 and one waveguide 5. FIG. 4 is a cross-sectional view of the alignment sensor AS, which is less enlarged than FIG. 3 and which therefore can show more windows and waveguides. Five waveguides 15a-e are all located beneath one another in the semiconductor chip 2 (i.e. they are substantially vertically aligned). The waveguides 15a-e are all provided at different depths such that they are separated in the z-direction. This allows the waveguides to pass to one end of the semiconductor chip 2 without intersecting with one another. Each of the waveguides 15a-e may have the structure shown in FIG. 3 (i.e. a core surrounded by cladding). However, this structure is omitted from FIG. 4 for simplicity of illustration. The waveguides 15a-e are configured to guide radiation in the x-direction. A discontinuity 14 is shown in FIG. 4, the discontinuity indicating that the waveguides 15a-e may be significantly longer than could be shown in FIG. 4. The waveguides 15a-e may for example extend for more than 1 cm, may extend for more than 2 cm, or may extend for more than 3 cm.

The waveguides 15a-e initially extend downwardly from the wavelength conversion material 4, then extend diagonally before finally extending horizontally. The downwardly extending portions of the waveguides 15a-e have different lengths, and the diagonally extending portions of the waveguides also have different lengths. This allows the horizontally extending portions of the waveguides 15a-e to be provided at different depths.

Some radiation may be lost as the radiation passes from the downwardly extending portion of a waveguide to the diagonally extending portion. Similarly, some radiation may be lost as the radiation passes from the diagonally extending portion of a waveguide to the horizontally extending portion. This will not affect the performance of the alignment sensor, provided that sufficient radiation is received at the detector to allow the radiation to be detected with a desired signal to noise ratio. It may be possible to use the alignment sensor effectively even if significant loss of radiation occurs in the waveguide (e.g. up to 80% loss of radiation).

If loss of radiation in the waveguide is likely to have a significant effect upon the performance of the alignment sensor, then the waveguide may be configured such that the loss of radiation is less than a desired amount. This may be achieved, for example, by ensuring that angles subtended between different portions of the waveguide do not exceed a predetermined value. It may be achieved by providing the waveguides with curves rather than corners.

If the amount of radiation emitted from the wavelength conversion material is sufficiently high, then the diagonal portion of the waveguides may be omitted. The waveguide may, for example, instead include a 90° corner. Some radiation may be lost at this corner, but sufficient radiation may be retained to allow the alignment sensor to be used effectively.

A detector 16a-e is provided at the end of each waveguide 15a-e, each detector being configured to detect radiation that has travelled along that waveguide. The detectors may, for example, be located in the semiconductor chip 2. Alternatively, the detectors may be located next to the semiconductor chip 2 (as shown), for example, being held in a substrate 17. The detectors 16a-e may, for example, be photodiodes. The detectors 16a-e may, for example, be provided in a two-dimensional array. The detectors 16a-e may, for example, be a CCD array. Output signals from the detectors 16a-e are passed to processing electronics (not illustrated).

As mentioned above, an opaque material 8 is provided on top of the semiconductor chip 2. The opaque material is provided with a series of windows 9. The windows 9 are periodically separated and therefore form a grating 1 in the opaque material 8. A piece of wavelength conversion material 4 is provided beneath each window 9. Each piece of wavelength conversion material 4 is separated by semiconductor material of the semiconductor chip 2. The semiconductor chip 2 may be formed from a material that is opaque to EUV radiation and is also opaque to radiation emitted by the wavelength conversion material 4. The semiconductor chip material may thereby prevent cross-talk occurring between pieces of wavelength conversion material. Additionally or alternatively, metal or some other material that is opaque to radiation emitted by the wavelength conversion material may be provided between waveguides in order to prevent cross-talk occurring between them. Metal may, for example, be provided at an outer boundary of the cladding 7. The metal may, for example, be a metal layer which has a thickness of less than 0.5 microns.

During alignment, EUV radiation is incident upon the alignment sensor AS. EUV radiation that is incident upon the opaque material 8 is blocked. However, EUV radiation that falls on the windows 9 passes through the windows and is incident upon the wavelength conversion material 4. The wavelength conversion material 4 emits radiation at a longer wavelength than EUV radiation (e.g. emitting visible or infrared radiation). This radiation is guided along the waveguides 15a-e and travels to the detectors 16a-e. Radiation received by the detectors may be used to obtain alignment between a mask MA and the substrate table WT (see FIG. 2).

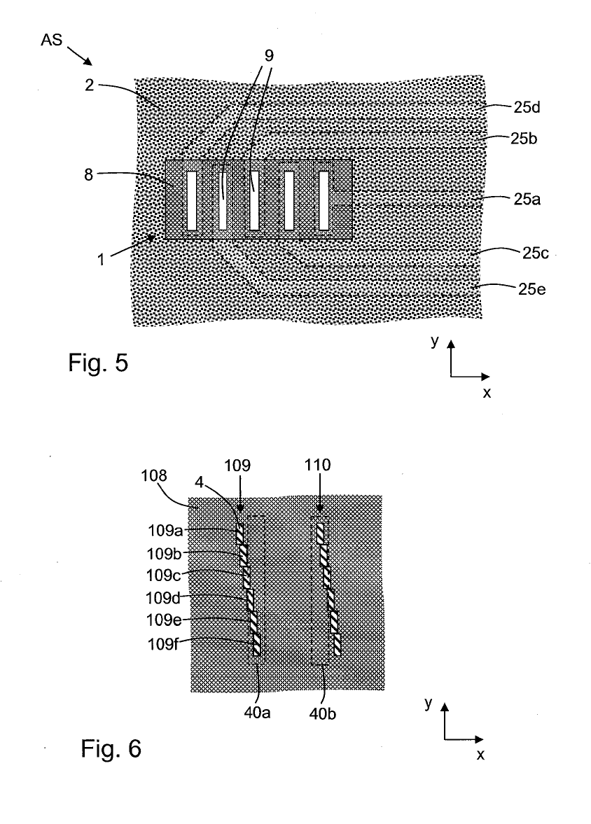

An embodiment of the invention is shown schematically in FIG. 5. FIG. 5 schematically shows part of an alignment sensor viewed from above in partial cross-section. Detectors are omitted from FIG. 5. However, detectors may be provided, for example, in the manner described above. The alignment sensor comprises a semiconductor chip 2 onto which an opaque material 8 has been provided. The opaque material 8 is provided with a series of windows 9, the windows having a periodic separation such that they form a grating 1. A series of waveguides 25a-e extend in the x-direction. Each waveguide 25a-e connects with a different window 9, and is configured to guide radiation in the x-direction. Although not shown in FIG. 5, wavelength conversion material is located at each window 9, the wavelength conversion material being configured to receive EUV radiation and emit radiation with a longer wavelength (e.g. visible or infrared radiation).

As may be seen from FIG. 5, each waveguide 25a-e is separated in the y-direction, thereby allowing radiation to be guided by the waveguides without cross-talk occurring between them. Since the waveguides are separated in the y-direction there is no need for them to be separated vertically (i.e. in the z-direction), although they may also be separated in this direction. The waveguides 25a-e may, for example, all pass along the semiconductor chip 2 at the same depth (although they may have different depths). Detectors (not shown) may, for example, be located at opposite ends of the waveguides 25a-e from the windows 9.

In embodiments of the invention (not illustrated), some waveguides may be separated in the z-direction and separated in the y-direction. The waveguides may have any suitable form. Although the portions of the waveguides that extend to the detectors extend in the x-direction in the Figures, the waveguides may extend in the y-direction, or in any other direction (e.g. substantially transverse (i.e. perpendicular) to an optical axis of the lithographic apparatus). Although the portions of the waveguides that extend to the detectors are parallel to one another in the figures, the waveguides may be non-parallel. Some waveguides may extend in opposite directions, substantially opposite directions, or different directions. Where this is the case, detectors may accordingly be provided at different locations to receive radiation that has been guided by the waveguides. Detectors may, for example, be located on different sides of the semiconductor chip 2.

A separate waveguide may be provided for each window. Alternatively, a waveguide may be configured to receive radiation from more than one window (following wavelength conversion by wavelength conversion material). A single waveguide may be provided for all windows. Similarly, a single piece of wavelength conversion material may be provided for all windows.

The alignment sensor AS may, for example, be used when it is desired to align a patterning device MA with a substrate table WT (see FIGS. 1 and 2). This may be achieved by directing EUV radiation through a grating provided on the patterning device MA such that an image of the grating is formed in the vicinity of the substrate table WT (referred to here as the mask grating image). The substrate table WT may be positioned such that the alignment grating AS overlaps with the mask grating image. The position of the substrate table WT relative to the mask grating image is measured, thereby allowing alignment between the patterning device MA and the substrate table to be achieved.

EUV radiation of the mask grating image that falls on the opaque material 8 of the alignment grating 1 is not transmitted and is therefore not detected by the detectors 16a-e. EUV radiation that falls upon the windows 9 (i.e., the transmissive portions of the alignment grating 1) is incident upon wavelength conversion material 4. This EUV radiation thus causes radiation to be emitted by the wavelength conversion material 4, the radiation travelling along the waveguides 15a-e, 25a-e to the detectors. The amount of radiation that is detected by the detectors depends upon the alignment of the mask grating image relative to the alignment sensor grating 1. If the grating image and the alignment sensor grating 1 both have the same period, then a maximum signal will be seen on the detectors when bright portions of the mask grating image are aligned with windows 9 of the alignment grating. A minimum signal will be seen when bright portions of the mask grating image are aligned with opaque material 8 of the alignment grating 1. An intermediate signal will be seen when bright portions of the mask grating image partially overlap with windows 9 of the alignment sensor grating 1.

In one alignment method, the substrate table WT is moved transverse to the z-direction (e.g. is moved in the x-direction) such that the alignment grating moves through the mask grating image. The intensity of radiation detected by the detectors is monitored during this movement, and the variation of intensity is used to determine the position of the alignment grating 1 relative to the mask grating image. This allows the position of the substrate table WT to be determined relative to the position of the patterning device, thereby allowing the patterning device and the substrate table to be aligned. A coarse alignment may already have been performed in order to ensure that the position of the grating 1 is within the capture range needed to achieve correct determination of the relative positions of the substrate table WT and the patterning device MA. This coarse alignment may, for example, be performed using another alignment grating having a longer period, or may be performed using some other alignment system.

In an embodiment, the output signals from the detectors 16a-e may all be added together so that a processor (not shown) processes a single radiation intensity value. Alternatively, a single detector may be used to detect the radiation delivered by the waveguides 15a-e, 25a-e instead of a plurality of detectors. Either of these approaches may allow alignment of the lithographic apparatus to be performed in the same way as is done in conventional lithographic apparatus (where a single photodiode is located directly beneath a substrate table alignment grating).

In an embodiment, the output signals from the detectors 16a-e may be processed individually by the processor. Where this is done, the processor is provided with more information than if only a single radiation intensity value is used. This may allow the processor to measure alignment in a different manner to the conventional manner. For example, the different intensities detected from each waveguide may be used to determine the relative positions of the substrate table WT and the patterning device MA while moving the substrate table through a smaller scanning movement than in prior art systems.

In an embodiment in which the output signals from the detectors 16a-e are processed individually by the processor, alignment may be measured without using a scanning movement of the substrate table WT (or of the patterning device MA). The aligned position of the substrate table WT (relative to the patterning device MA) may be determined by comparing the output signals from the detectors 16a-e to see which detector has the highest output signal. The detector that has the highest output signal may be considered to indicate a central point of the pattern projected from the patterning device MA, and this information may be used to achieve alignment of the substrate table WT and patterning device.

An embodiment of the invention which may be used when determining alignment without using a scanning movement of substrate table WT (or of the patterning device MA) is shown schematically in FIG. 6. FIG. 6 shows part of an alignment sensor viewed from above. A layer of material 108 which is opaque to EUV radiation is provided, the layer of material having two sets of windows 109, 110. Wavelength conversion material 4 is provided in each window. A waveguide (not shown) passes from each window to a detector (also not shown) in the same manner as described above in relation to other embodiments. The waveguide may have properties as described above in relation to other embodiments.

The windows 109, 110 are staggered in the x-direction. That is, each of the windows of a given set of windows 109, 110 is offset in the x-direction relative to adjacent windows. The x-direction offsets may be equal to one another or may be different. The x-direction offsets may be the same for each set of windows 109, 110 or may be different.

Also shown in FIG. 6 are images of two alignment grating lines 40a, 40b. The images are formed by EUV radiation which has passed through openings of a grating in a patterning device MA (see FIG. 2), the openings being imaged onto the layer of material 108 by the projection system PS. As may be seen, the images 40a, 40b partially overlap with the sets of windows 109, 110.

Referring to the first image 40a, it may be seen that the image does not overlap with first and second windows 109a, 109b of the set of windows. The image partially overlaps with third and fourth windows 109c, 109d of the set of windows 109a and is fully overbid over fifth and sixth windows 109e, 109f of the set of windows. Detectors which detect radiation emitted by wavelength conversion materials 4 located in the windows therefore output signals which may be used to determine the position in the x-direction of the image 40a. Little or no radiation will be received from the first two windows 109a, 109b of the set of windows. A small amount of radiation will be received from the third window 109c and a larger amount of radiation will be received from the fourth window 109d. A still larger amount of radiation will be received from the fifth and sixth windows 109e, 109f. A processor of the lithographic apparatus may thus determine the position of a left hand edge of the image 40a, and may thereby determine the position of the image.

Referring to the second image 40b, it may be seen that the image overlaps in a different manner with the set of windows 110. Again, the intensity of radiation detected by detectors connected to the windows allows the position of the image 40b to be determined.

The sets of windows 109, 110 allow the positions of the images 40a, 40b of lines of a patterning device MA alignment mark to be determined without scanning movement of the substrate table WT. This allows alignment of the substrate table WT relative to the patterning device MA to be determined without performing a scanning movement of the substrate table.

Although only two sets of windows 109, 110 are shown in FIG. 6, any suitable number of sets of windows may be used. Similarly, although each set of windows 109, 110 comprises six windows, a set of windows may comprise any suitable number of windows. Although each window is referred to as having a separate waveguide and detector, more than one window may be associated with a given waveguide. A detector may receive radiation from more than one window.

The differences in x-direction positions of the windows 109, 110 may determine the accuracy with which the alignment of the substrate table WT relative to the patterning device MA may be determined. Staggering the windows with a smaller separation may provide a higher accuracy of alignment measurement, and staggering with a larger spacing may provide a lower accuracy of alignment measurement.

Sets of windows which extend in the y-direction may be provided in order to allow alignment of the substrate table WT relative to the patterning device MA in the y-direction.

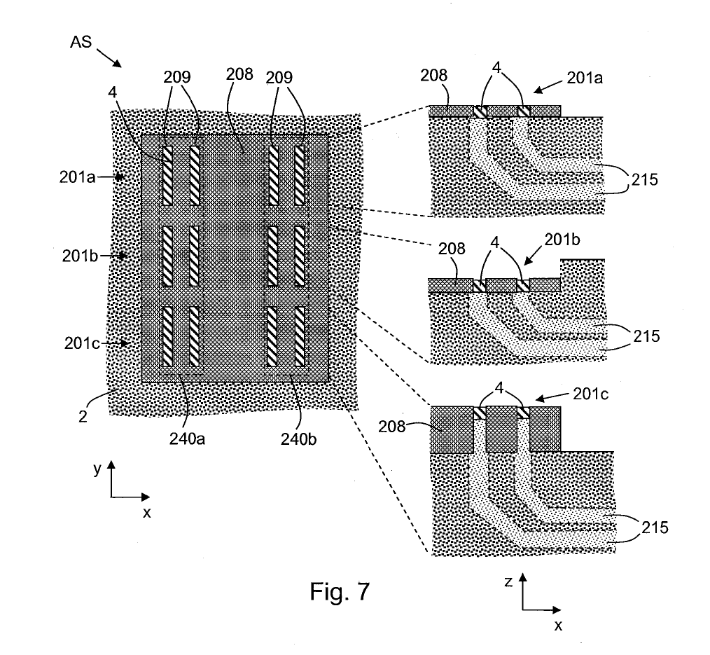

FIG. 7 shows schematically viewed from above part of an alignment sensor AS according to an embodiment of the invention. Three alignment gratings 201a-c are formed in a layer of material 208 which is opaque to EUV radiation. The gratings 201a-c comprise windows 209, each window being provided with wavelength conversion material 4.

The right hand side of FIG. 7 schematically shows in cross-section some of the windows of the first grating 201a, some of the windows of the second grating 201b and some of the windows of the third grating 201c. In each instance, wavelength conversion material 4 is provided in the windows and waveguides 215 pass through semiconductor material 2 to detectors (not shown).

In the first grating 201a, the windows are provided at or close to the surface of the semiconductor material. In the second grating 201b, the windows are provided in a recess in the semiconductor material. Because the windows are provided in a recess, they have a lower position in the z-direction than the windows of the first grating 201a. In the third grating 201c, the windows are provided above the semiconductor material, the layer of EUV opaque material 208 having been provided as a thicker layer in this location in order to allow the windows to be raised relative to the semiconductor material. The windows of the third grating 201c are higher in the z-direction than the first set of windows 201a. The windows of the gratings 201a-c are provided at different heights.

As may be seen, in each case, the wavelength conversion material 4 is located at or adjacent to an upper surface of the windows.

The embodiment shown in FIG. 7 allows the position of the alignment sensor AS relative to an image focal plane of the projection system PS to be determined. In FIG. 7, images 240a, 240b of alignment mark lines provided in a patterning device MA are shown. The images are shown as having sharp edges. However, in practice, the sharpness of the edges of the image will depend upon the position in the z-direction relative to the image focal plane of the projection system. Taking as an example the case in which the upper surface of the semiconductor material 2 lies in the image focal plane of the projection system, the alignment grating line images 240a, 240b will have sharp edges in the vicinity of the first alignment grating 201a because the first alignment grating lies in or close to the image focal plane of the projection system. The second alignment grating 201b will be beneath the image focal plane of the projection system. As a result, the alignment grating images 240a, 240b will have diffuse edges, and the intensity of radiation incident upon the windows of the second alignment grating 201b will be reduced. Similarly, the third alignment grating 201c will lie above the image focal plane, and as a result the edges of the alignment grating images 240a, 240b will be diffuse and the intensity of radiation incident upon the windows of the third alignment grating will be reduced.

A processor connected to detectors (not shown) which receive radiation emitted by the wavelength conversion material 4 will determine, based upon the intensity of radiation received at the detectors, that the image focal plane corresponds with the position in the z-direction of the first alignment grating 201a (or that it is closer to this plane than to the planes of the second or third alignment gratings 201b, 201c). The alignment sensor AS thus allows the position of the substrate table WT relative to the image focal plane of the projection system PS to be determined without performing a scanning movement of the substrate table in the z-direction.

Although alignment gratings at three different z-direction levels are shown in FIG. 7, any suitable number of alignment gratings may be provided. The alignment gratings may be provided at any suitable combination of heights. The accuracy with which the z-direction position of the substrate table WT may be determined may depend upon the z-direction separation between alignment gratings 201a-c.

Although three alignment gratings 201a-c are shown in FIG. 7, any number of alignment gratings may be provided. For a given z-direction separation of alignment gratings, increasing the number of alignment gratings will increase the capture range over which the position of the focal plane of the projection system PS may be determined.

The z-direction separation of the alignment gratings will determine the accuracy with which the position of the focal plane of the projection system may be determined. Reducing the z-direction separation will increase the accuracy, and increasing the z-direction separation will reduce the accuracy.

In addition to obtaining information about the position of the substrate table WT in the z-direction, the alignment sensor AS shown in FIG. 7 may also be used to determine x-direction alignment of the substrate table WT relative to the patterning device MA.

Features described further above in relation to the embodiments illustrated in FIGS. 3-5 may also be applied to the embodiment illustrated in FIGS. 6 and 7. Indeed, features of any embodiments of the invention may be combined with one another.

The wavelength conversion material 4 may have an upper surface which is substantially co-planar with an upper surface of the EUV opaque material 8. The wavelength conversion material 4 may be provided at any suitable height relative to the EUV opaque material 8.

In an embodiment in which alignment is measured without using a scanning movement of the substrate table, the period of the alignment sensor grating may be different from the period of the mask grating image. Where this is the case, each window of the alignment sensor grating will have a slightly different overlap with the mask grating image. This allows more information to be gathered regarding the relative position of the alignment sensor and the mask grating image than would be the case if alignment sensor grating had the same period as the mask grating image.

In embodiments in which scanning movement of the substrate table WT is not needed in order to align the substrate table with the patterning device MA, alignment may be performed more quickly, thereby allowing the throughput of the lithographic apparatus to be increased.

In embodiments of the invention, the waveguides may be embedded in semiconductor material (e.g. in a semiconductor chip). The waveguides may be considered to be integrally formed within the semiconductor material (e.g. semiconductor chip). The wavelength conversion material and alignment grating may also be considered to be integrally formed with the semiconductor material. In this context, the term ‘integrally formed’ may be considered to mean that the waveguides, the wavelength conversion material, alignment grating and semiconductor material (e.g. semiconductor chip) form a solid block. This construction may be advantageous because the alignment sensor of embodiments of the invention is robust, compared with, for example, an alignment sensor comprising separately provided alignment grating, wavelength conversion material, optical fiber, and detector, which are connected together. The alignment sensor may be more stable than an alignment sensor comprising separately provided components, since the components are less likely to move relative to one another. The alignment sensor may also have a longer life than an alignment sensor comprising separately provided components, since the separately provided components are more likely to become detached from one another.

In embodiments in which a separate waveguide is provided for each window of the diffraction grating, the diffraction grating may have any desired length. If a single waveguide were to be used to collect all radiation transmitted by the diffraction grating, then this would limit the length of the diffraction grating, since properties of the waveguide may restrict the cross-sectional area of the waveguide.

When separate waveguides and separate detectors are used for each window of the diffraction grating, a large amount of information is available to the processor. As a result, the alignment sensor may be used to measure properties other than the relative positions of the patterning device MA and substrate table WT (i.e. the sensor is not merely an alignment sensor). For example, properties of the EUV radiation beam may be measured by the sensor. These properties may include spatial and/or temporal variation of the intensity of the EUV radiation beam, aberration of the radiation beam, the position of the focal plane of the radiation beam, etc. The properties may be measured by using the patterning device MA to position an appropriate aperture or pattern in the EUV radiation beam, then measuring radiation that is received by different detectors of the sensor, e.g. as a function of the position of the alignment sensor and/or the patterning device MA.

In a conventional alignment sensor, a detector is located immediately beneath the alignment grating. The detector detects radiation that is transmitted by the alignment grating and transmits an electrical signal. The detector may be a significant source of heat, and this heat may introduce errors into alignment measurements. The alignment sensor may, for example, be located at an edge of the substrate table WT, and heat from the detector may cause distortion of the edge of the substrate table. If an interferometer is used to measure the position of the substrate table WT, then this distortion of the edge of the substrate table may introduce an error into the measured position of the substrate table.

Embodiments of the invention may avoid this disadvantage because the detectors are located away from the alignment grating (and may be located away from an edge of the substrate table WT). The detectors may, for example, be located sufficiently far from the alignment grating that heat emitted by the detectors does not reach the alignment grating, or sufficiently far that heat that reaches the detectors does not have a significant effect upon alignment measurements. For example, the detectors may be located sufficiently far from the alignment grating that heat emitted by the detectors does not cause mechanical distortion of the substrate table WT between the alignment grating and a substrate held on the substrate table WT. In addition, detectors may, for example, be located sufficiently far from the edge of the substrate table WT that heat emitted by the detectors does not reach an adjacent edge of the substrate table, or sufficiently far that heat does not cause significant distortion between the alignment mark and an adjacent edge of the substrate table.

The detectors may, for example, be provided at a location that is adjacent to a cooling apparatus, e.g. an active cooling apparatus such as an apparatus that uses water circulation.

In an embodiment, detectors are not provided at the end of the waveguides. Instead, additional waveguides may be provided, the additional waveguides being arranged to receive radiation that has travelled along the waveguides, and to guide that radiation. Detectors may be provided at far ends of the additional waveguides. The additional waveguides may for example be optical fibers, or may be formed in a semiconductor material. The additional waveguides may, for example, be used to carry radiation to a location in the substrate table WT that is located away from the alignment sensor AS (e.g. located away from the semiconductor chip). This may reduce the likelihood of unwanted thermal effects affecting alignment measurements. The additional waveguides may, for example, be used to carry radiation to a location that is located away from the substrate table WT. This may be done for example via optical fibers that pass as a cable from the substrate table. The signals may however also be transported via “open space”, for example by transporting radiation from the wafer stage WS to a detector on the wall of the vacuum vessel by using a LED on the wafer stage WS and a photodiode on the wall of the vacuum vessel.

Wavelength conversion materials 4 that emit different wavelengths of radiation may be used. Referring to FIG. 4 for example, the wavelength conversion material associated with each waveguide 15a-e may emit a different wavelength. Where this is the case, radiation that travels to ends of the waveguides 15a-e may be multiplexed into a single additional waveguide (e.g. an optical fiber). The multiplexed radiation may travel along the additional waveguide and then be de-multiplexed at an opposite end of the additional waveguide and detected. The de-multiplexer may, for example, comprise one or more gratings that are configured to direct the radiation towards different detectors in a wavelength-dependent manner.

In an embodiment, instead of different wavelength conversion materials 4 emitting different wavelengths of radiation, wavelength conversion materials may emit broad-band radiation. Filters may be provided in the waveguides, each waveguide being provided with a different filter, the different filters being configured to select a different wavelength of radiation for each waveguide. The filters may for example be Bragg gratings. Wavelength based multiplexing may be used with this embodiment in the manner explained above.

In an embodiment, time division multiplexing may be used instead of wavelength based multiplexing. This may be achieved by applying different delays to pulses of radiation emitted by different wavelength conversion materials 4. The lithographic apparatus generates pulsed EUV radiation, and as a result the radiation emitted by the wavelength conversion materials will naturally be pulsed, all of the pulses being generated at the same time. The pulses may be separated in time by providing the waveguides with different lengths, or by providing photonic crystals arranged to delay the propagation of the radiation emitted by the wavelength conversion materials 4. Pulses of radiation emitted by the wavelength conversion materials 4 may thus be arranged to arrive at a detector in series, thereby allowing the detector to separately detect the pulses.

In illustrated embodiments of the invention, an alignment grating that extends in the x-direction is shown. An alignment grating that extends in the y-direction may be provided. A pair of alignment gratings that extend in perpendicular directions may be provided.

In an embodiment, the alignment grating may comprise a two-dimensional array of windows. The windows may be shaped as rectangles (for example comprising a set of squares in a chess-board type configuration). Where this is the case, the same alignment grating may be used to obtain alignment in two perpendicular directions (e.g. the x-direction and the y-direction). Different waveguides may extend from each window of the alignment grating. At least some of the waveguides may extend to different depths in order to allow the waveguides to move away from the alignment grating without crossing one another. The detectors may, for example, be provided in an array. The detectors may for example comprise a CCD array.

In an embodiment, radiation that is detected may be converted into a digital signal by the processor. A radiation emitter (e.g. an LED) on the substrate table WT may be arranged to emit modulated radiation that represents the digital signal. A detector (e.g. a camera) located away from the substrate table may be used to detect the digital signal emitted by the radiation emitter. The signal detected by the detector may then travel to a controller, processor or other electronics that forms part of the lithographic apparatus.

A waveguide may include a dopant that may be used to amplify the radiation that is travelling along the waveguide. The dopant may, for example, be Ce in YAG:Ce, or any other suitable material. Optical pumping of the dopant may, for example, be provided using LEDs or other optical sources that have a wavelength that is sufficiently short to excite the dopant to an excited state (the wavelength is generally shorter than the wavelength of radiation that is emitted from the wavelength conversion material and that travels along the waveguide). The optical pumping may be done by using optical sources included in the substrate table or by using optical sources not incorporated into the substrate table (for instance by transporting the light for pumping via an optical fiber to the required location). Dopant may be provided in the waveguide if the loss of radiation is expected to be so high that an undesirably low signal to noise ratio will be seen at the detector. Also a suitable non-linear crystalline material may be used to amplify the radiation in the waveguide, such as a non-linear crystalline material without inversion symmetry used for optical parametric amplification. Examples of suitable non-linear crystalline material are for instance lithium niobate (LiNbO₃), lithium tantalate (LiTaO₃), potassium niobate (KNbO₃), potassium titanyl phosphate (KTP, KTiOPO₄), KTA (KTiOAsO₄), potassium dihydrogen phosphate (KDP, KH₂PO₄), RTP (RbTiOPO₄), RTA (RbTiAsPO₄), germanium diphosphide (ZGP, ZnGeP₂), silver gallium sulfide and selenide (AgGaS₂ and AgGaSe₂), gallium selenide (GaSe) and cadmium selenide (CdSe).

The semiconductor chip 2 may include other components that may be useful during operation of the lithographic apparatus. For example, the semiconductor chip 2 may include alignment gratings (or other alignment marks), which may be used to measure the alignment of substrates W relative to the substrate table WT. The alignment gratings may, for example, be formed using aluminium or some other suitable masking material. The alignment gratings may be unconnected to optical sensors, waveguides or other components.

A layer of zirconium (not shown) may be provided over the windows 9, 109, 209 (and optionally also over the opaque material 8). The zirconium transmits the majority of EUV radiation that is incident upon it but blocks other wavelengths (e.g. infrared, visible, DUV) that may be emitted by the source collector module SO. The zirconium may thus help to reduce or eliminate the influence of non-EUV radiation on measurements made using the sensor AS. The zirconium layer may, for example, be around 100 nm thick, or may have any other suitable thickness. The zirconium layer may be covered with a protective layer to prevent oxidation. The protective layer may, for example, be TiN (e.g. around 10 nm thick), or may be any other suitable material. A different material may be used instead of zirconium to block non-EUV radiation while allowing EUV radiation to be transmitted.

In illustrated embodiments of the invention, the windows 9 are open space. However, the windows 9 may comprise material that allows the transmission of at least some EUV radiation (i.e. such that EUV radiation travels through the material to the wavelength conversion material 4). The windows 9 may, for example, be formed from SiO₂, or may be formed from any other suitable material.

The wavelength conversion material may be provided in the windows 9, 109, 209 instead of being provided beneath the windows. The wavelength conversion material may be provided in part in the windows 9, 109, 209 and in part below the windows. The wavelength conversion material 4 may be provided above the windows, or in part above the windows. Where this is the case, some of the radiation emitted by the wavelength conversion material may be blocked by the opaque material 8. In general, the wavelength conversion material may be said to be located at the windows, meaning that the wavelength conversion material may be located on top, in and/or beneath the window.

As mentioned further above, the waveguides may be considered to be embedded in the semiconductor material (e.g. semiconductor chip 2). The waveguides may be considered to be provided in conduits formed in the semiconductor material (e.g. semiconductor chip 2). The waveguides and the semiconductor chip 2 may be considered to form a solid block (i.e. no air being present at boundaries between the waveguides and the semiconductor chip).

Although the windows 9, 109, 209 form a grating in illustrated embodiments, the windows may be arranged to form any desired pattern. The term ‘window’ is not intended to imply that the window is entirely surrounded by opaque material 8. Opaque material may be omitted from one or more sides of the windows 9, 109, 209.

Although the waveguides 5, 15 have been shown beneath the wavelength conversion material 4 in embodiments of the invention, in other embodiments, one or more waveguides may be located in some other position. For example, a waveguide may be located to one side of a piece of waveguide conversion material.

It is not essential that the waveguide is in contact with the wavelength conversion material. For example, there may be a gap between the wavelength conversion material and the waveguide. The gap may be filled with a material that provides a degree of refractive index matching between the wavelength conversion material and the waveguide.

The term “semiconductor chip” may be interpreted as meaning a piece of semiconductor (e.g. a block of semiconductor). Semiconductor waveguides of embodiments of the invention are provided within the piece of semiconductor.

The semiconductor chip is an example of a block of material within which an embedded waveguide may be provided. In an alternative example, the block of material may be a dielectric, for example glass, quartz, or some other suitable dielectric. An embedded waveguide may be formed in the block of dielectric by locally changing the refractive index of the dielectric along the desired path of the waveguide. This may be done in a glass block for example by using laser pulses to locally change the refractive index.

The term ‘waveguide’ may be considered to mean a structure that guides radiation. The waveguide may comprise a central portion formed from material with a higher refractive index than adjacent material, e.g. such that total internal reflection occurs at the boundary between the central portion and the adjacent material. The adjacent material may, for example, be cladding that surrounds the central portion (which may be a core of the waveguide). Alternatively, the waveguide may comprise a central portion that is surrounded by metal. The metal may act to confine the radiation emitted by the wavelength conversion material such that the radiation is guided along the waveguide (the central portion acting as a guide). The central portion surrounded by metal may for example be air or may be semiconductor (e.g. SiO₂).

In an embodiment, the waveguide may comprise photonic crystals embedded in the semiconductor chip (or block of other material), the photonic crystals acting as waveguides.

Cartesian coordinates have been used when describing embodiments of the invention since this is a convenient way of expressing information. The Cartesian coordinates should not be taken to imply that the invention or components of the invention must have a particular orientation.

Where a material is described as being “opaque” this does not necessarily mean that absolutely no radiation passes through it. A small amount of radiation may pass through the material, but this is significantly less than the amount of radiation that passes through a material designed to transmit the radiation (e.g. waveguide core material).

Although described embodiments of the invention are directed towards measurement of EUV radiation, embodiments of the invention may be used to measure radiation at other wavelengths. For example embodiments of the invention may be used to measure DUV radiation (e.g. at wavelengths used by DUV lithographic apparatus).

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The term “lens”, where the context allows, may refer to any one or combination of various types of optical components, including refractive, reflective, magnetic, electromagnetic and electrostatic optical components.

The term “EUV radiation” may be considered to encompass electromagnetic radiation having a wavelength within the range of 5-20 nm, for example within the range of 13-14 nm, or example within the range of 5-10 nm such as 6.7 nm or 6.8 nm.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein. The descriptions above are intended to be illustrative, not limiting. Thus it will be apparent to one skilled in the art that modifications may be made to the invention as described without departing from the scope of the claims set out below.

What is claimed is:

1. A substrate table with a sensor, the sensor comprising:
a block of material provided with a layer of material opaque to radiation, the layer of opaque material having at least one window configured to allow the transmission of the radiation;
a wavelength conversion material located at the window; and
a waveguide positioned to receive radiation emitted by the wavelength conversion material, the waveguide being embedded in the block of material and being configured to guide radiation emitted by the wavelength conversion material through the block of material and towards a detector.

2. The substrate table of claim 1, wherein the block of material is a semiconductor chip or a dielectric block.

3. The substrate table of claim 1, wherein the layer of opaque material and the window form part of a diffraction grating.

4. The substrate table of claim 1, wherein the window is one of a plurality of windows.

5. The substrate table of claim 4, wherein a set of windows extends in a first direction, and wherein at least some of the windows have different positions in a second direction, the second direction being transverse to the first direction.

6. The substrate table of claim 4, wherein at least some of the windows are provided at different heights.

7. The substrate table of claim 4, wherein each window is provided with a separate piece of wavelength conversion material.

8. The substrate table of claim 4, wherein the waveguide is one of a plurality of waveguides.

9. The substrate table of claim 4, wherein each window is associated with a different waveguide.

10. The substrate table of claim 4, wherein:
a) the wavelength conversion material located at one or more of the plurality of windows, and/or
b) filters provided in one or more waveguides,
are configured to select from the wavelength range of 500-2000 nm one or, more different wavelengths of radiation.

11. The substrate table of claim 1, wherein the detector is one of a plurality of detectors.

12. The substrate table of claim 11, wherein output signals from the plurality of detectors are processed individually by a processor.

13. The substrate table of claim 8, wherein at least some of the waveguides extend to different depths within the semiconductor chip.

14. The substrate table of claim 1, wherein a dopant or a non-linear crystalline material configured to amplify the radiation emitted by the wavelength conversion material is provided in the waveguide, and wherein an optical pump is arranged to directly pump radiation into the waveguide, the pump radiation having a wavelength configured to excite the dopant or amplify the signal in the non-linear crystalline material.

15. The substrate table of claim 1, wherein the wavelength conversion material is configured to emit radiation having a wavelength in the wavelength range 500-2000 nm when EUV radiation is incident upon the wavelength conversion material.

16. The substrate table of claim 1, wherein the layer of opaque material is opaque to EUV radiation and/or is opaque to radiation in the wavelength range 500-2000 nm.

17. A lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate table with a sensor, the sensor comprising
a block of material provided with a layer of material opaque to radiation, the layer of opaque material having at least one window configured to allow the transmission of the radiation,
a wavelength conversion material located at the window, and
a waveguide positioned to receive radiation emitted by the wavelength conversion material, the waveguide being embedded in the block of material and being configured to guide radiation emitted by the wavelength conversion material through the block of material and towards a detector,
the substrate table being constructed to hold a substrate; and
a projection system configured to project the patterned radiation beam onto a target portion of the substrate.

18. A device manufacturing method comprising:
using a lithographic apparatus comprising an illumination system configured to condition a radiation beam; a support constructed to support a patterning device, the patterning device being capable of imparting the radiation beam with a pattern in its cross-section to form a patterned radiation beam; a substrate table with a sensor, the sensor comprising a block of material provided with a layer of material opaque to radiation, the layer of opaque material having at least one window configured to allow the transmission of the radiation, a wavelength conversion material located at the window, and a waveguide positioned to receive radiation emitted by the wavelength conversion material, the waveguide being embedded in the block of material and being configured to guide radiation emitted by the wavelength conversion material through the block of material and towards a detector, the substrate table being constructed to hold a substrate; and a projection system configured to project the patterned radiation beam onto a target portion of the substrate;
using the sensor to measure an optical property of an EUV radiation beam; and
using the sensor to measure alignment of the substrate table and the patterning device.

19. A device manufacturing method comprising:
patterning an EUV beam of radiation with a pattering device;
projecting a patterned beam of radiation onto a substrate supported by a substrate table with a projection system;
measuring an optical property of the EUV radiation beam with a sensor in the substrate table, the sensor comprising a block of material provided with a layer of material opaque to radiation, the layer of material having at least one window configured to allow the transmission of the radiation, a wavelength conversion material located at the window, and a waveguide positioned to receive radiation emitted by the wavelength conversion material, the waveguide being embedded in the block of material and being configured to guide radiation emitted by the wavelength conversion material through the block of material and towards a detector; and
measuring alignment of the substrate table and the patterning device with the sensor.
